(19) United States
(12) Patent Application Publication
(10) Pub. No.: US 2008/0183448 A1
(43) Pub. Date: Jul. 31, 2008

(54) ATTRIBUTIVE DATA PREDICTION APPARATUS, AN ATTRIBUTIVE DATA PREDICTION METHOD AND A RECORDING MEDIUM STORING AN ATTRIBUTIVE DATA PREDICTION PROGRAM

(75) Inventor: Nobutaka Itoh, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/018,660

(22) Filed: Jan. 23, 2008

(30) Foreign Application Priority Data
Jan. 29, 2007 (JP) JP2007-017235

(51) Int. Cl. G06G 7/64; G06G 7/56

(52) U.S. Cl. 703/7; 703/6

(57) ABSTRACT

The disclosed apparatus includes a storage unit storing differential information between a simulated value of attributive data of a product and an actually measured value of the attributive data of the product, a prediction unit predicting attributive data of a new product by simulation using design information of the new product, and a correction unit correcting the simulated attributive data of the new product based on stored differential information.

### CROSS-REFERENCE TO RELATED APPLICATIONS

This application is related to and claims the benefit of priority from Japanese Patent Application No. 2007-17235, filed on Jan. 29, 2007, the entire contents of which are incorporated herein by reference.

### BACKGROUND

1. Field

The present technique relates to prediction of attributive data of a product based on design information of the product and a simulation.

2. Description of the Related Art

A simulation technique using the finite-element method, for example, is utilized to predict attributive data of a product based on design information. A designer can obtain attributive data of a product by the simulation technique without actually producing the product.

The challenges dealt with in the simulation technique are to improve prediction accuracy of the simulation and to increase speed of the simulation.

Although typical simulation techniques may be utilized to predict attributive data, there is a need for an efficient and accurate attribute data prediction apparatus and method.

### SUMMARY

The disclosed apparatus includes a storage unit storing differential information between a simulated value of attributive data of a product and an actually measured value of the attributive data of the product, a prediction unit predicting attributive data of the new product by simulation of the new product using design information of the new product, and a correction unit correcting the simulated attributive data of the new product based on the differential information stored.

The disclosed method includes predicting attributive data of a new product by simulation using design information thereof and correcting the predicted attributive data of the new product based on differential information between a simulated value of attributive data of at least one other product and an actually measured value of the attributive data of said at least one other product.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram illustrating a circuit board deformation prediction apparatus.

FIG. 2 illustrates one example of a data structure of a warp correction value database.

FIG. 3 illustrates an example of a data structure of a warp correction value database.

FIG. 4 is a flowchart illustrating operations executed by a circuit board deformation prediction apparatus.

FIG. 5 is a flowchart illustrating operations executed by a circuit board deformation prediction apparatus.

FIG. 6 is a flowchart illustrating operations executed by a circuit board deformation prediction apparatus.

FIG. 7 is a graph illustrating one example of measurement results of circuit board warp values.

FIG. 8 is a graph illustrating an example of measurement results of circuit board warp values.

FIG. 9 illustrates one example of warp correction values.

FIG. 10 illustrates another example of the warp correction values.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

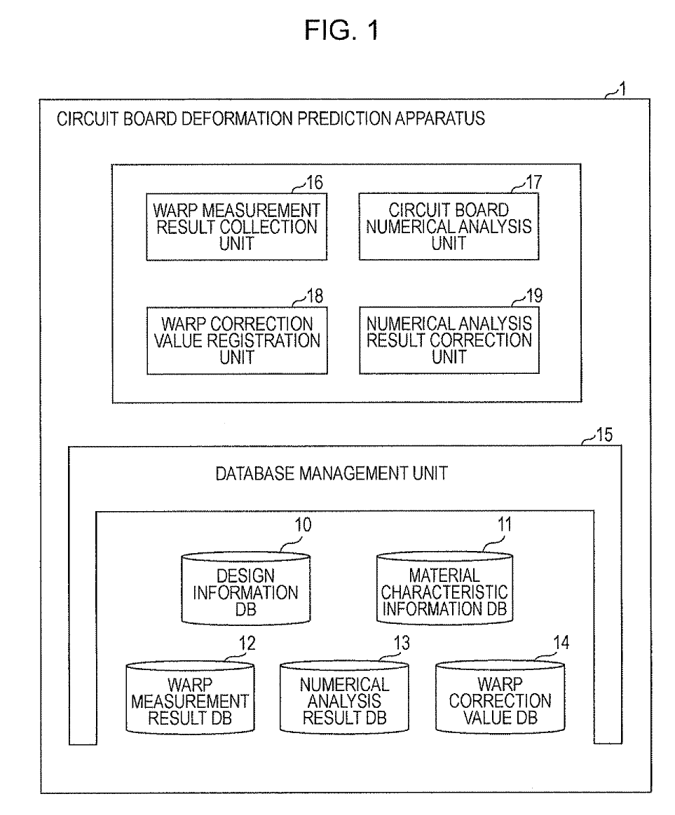

FIG. 1 illustrates a block diagram of one embodiment of a circuit board deformation (warp) prediction apparatus 1.

The circuit board deformation prediction apparatus 1 predicts a warp value of a circuit board undergoing a condition such as heating, which has a laminated structure and includes electronic parts mounted thereto. To execute the prediction, the circuit board deformation prediction apparatus 1 may include a design information database (DB) 10, a material characteristic information database (DB) 11, a warp measurement result database (DB) 12, a numerical analysis result database (DB) 13, a warp correction value database (DB) 14, a database management unit 15. As illustrated in FIG. 1, the circuit board deformation prediction apparatus 1 may also include a warp measurement result collection unit 16, a circuit board numerical analysis unit 17, a warp correction value registration unit 18, and a numerical analysis result correction unit 19.

The design information database 10 manages design information of a circuit board which is a target of the prediction of a warp value. The design information may be prepared using, e.g., CAD and may be registered in the design information database 10.

The material characteristic information database 11 manages characteristic information of materials described in the design information. The characteristic information of the materials includes information of properties including those depending on temperature.

The warp measurement result database 12 manages warp value measurement results of the circuit board which has been subjected to measurement of a warp value. The warp value of the circuit board may be measured through operations of heating the circuit board while changing a temperature condition, and measuring the warp value of the circuit board under the heating at each temperature condition by the moiré interference method, the laser displacement measurement method, etc.

The numerical analysis result database 13 manages numerical analysis results of circuit board warp values, which are obtained by a numerical analysis.

The warp correction value database 14 manages, as a warp correction value, a differential value between a measurement result of the warp value, which is stored in the warp measurement result database 12, and the numerical analysis result of the warp value, which is stored in the numerical analysis result database 13.

The database management unit 15 manages the design information database 10, the material characteristic information database 11, the warp measurement result database 12, the numerical analysis result database 13, and the warp correction value database 14.

The warp measurement result collection unit 16 collects the measurement results of the circuit board warp values and registers the collected measurement results in the warp measurement result database 12.

The circuit board numerical analysis unit 17 performs a numerical analysis of the circuit board and registers the numerical analysis result in the numerical analysis result database 13. The circuit board numerical analysis unit 17 performs the numerical analysis based on design information and material characteristic information. One example of the numerical analysis performed by the circuit board numerical analysis unit 17 is described in a Non-Patent Document 1, i.e., Nobutaka Ito et al., “Studies on warp analysis technique for printed wiring board”, Proceedings of 12-th Symposium on Micro-Bonding and Packaging Techniques in Electronics held under the sponsorship of Micro-Bonding Research Committee, Japan Welding Society, Vol. 12, pp. 461-466, 2006.

The warp correction value registration unit 18 calculates a differential value between the measurement result of the circuit board warp value and the numerical analysis result of the circuit board warp value. Further, the warp correction value registration unit 18 registers the calculated differential value as the warp correction value in the warp correction value database 14.

When there is a request for predicting a warp value of a new circuit board, the numerical analysis result correction unit 19 outputs a corrected numerical analysis result as the numerical analysis result. In other words, the numerical analysis result correction unit 19 corrects a numerical analysis result of the new circuit board by using the warp correction value.

The warp measurement result collection unit 16, the circuit board numerical analysis unit 17, the warp correction value registration unit 18, and the numerical analysis result correction unit 19 can be implemented in the form of computer programs. The computer programs may be recorded on a computer-readable recording medium or transmitted via a network. Further, a unit, such as a CPU, etc., can implement the disclosed process or operation by executing the computer programs.

The numerical analysis result correction unit 19 reads the warp correction value from the warp correction value database 14. Then, the numerical analysis result correction unit 19 corrects the numerical analysis result, which has been analyzed by the circuit board numerical analysis unit 17, by using the warp correction value. The numerical analysis result correction unit 19 can read the warp correction value of the circuit board, which is similar to the structure of the circuit board having been subjected to the numerical analysis, by utilizing a data structure of the warp correction value database 14.

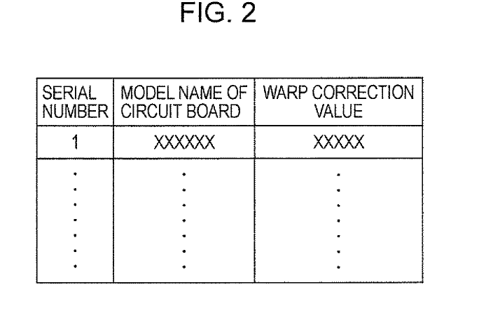

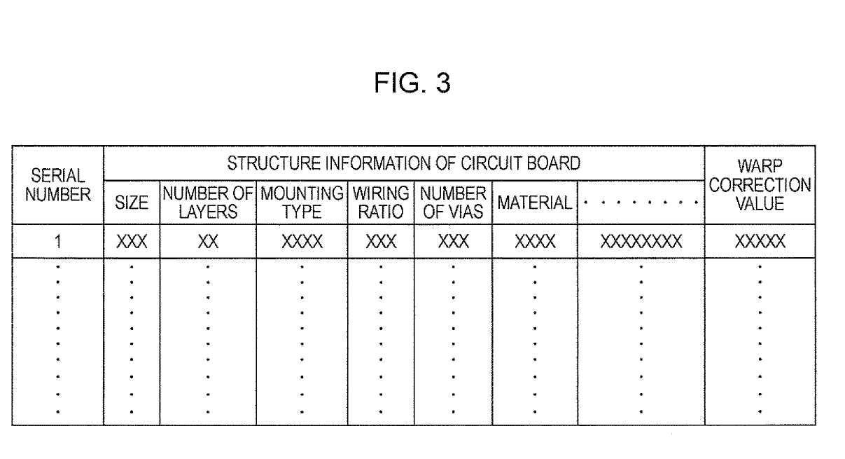

FIGS. 2 and 3 each illustrate an example of a data structure of the warp correction value database 14.

By utilizing the data structure of the warp correction value database 14 shown in FIG. 2, the numerical analysis result correction unit 19 can obtain, based on a model name (or a model number, or other similar identifying information) of a circuit board, the warp correction value of that circuit board.

When an electronic device is improved, a structure of a circuit board for the electronic device after the improvement is often similar to the structure of the circuit board for the electronic device before the improvement.

The warp correction value registration unit 18 registers the warp correction value of the circuit board in the warp correction value database 14 in a corresponding relation to the model name of the circuit board.

Based on the data structure of the warp correction value database 14 shown in FIG. 3 and values of structure items of the circuit board, the numerical analysis result correction unit 19 can obtain the warp correction value of the relevant circuit board.

The values of the structure items of the circuit board represent a size of the circuit board, a number of layers, a mounting type, a wiring ratio, a number of vias, a kind of material, etc. Examples of the circuit board include a circuit board for mounting an FBGA (Fine Pitch Ball Grid Array) LSI, a circuit board for mounting a CSP (Chip Scale Package) LSI, and a circuit board for mounting a POP (Package on Package) LSI. While FIG. 3 is described with specific items, the disclosed system and method is not limited to managing and/or storing any particular item related to a circuit board.

The warp correction value database 14 manages the warp correction value in accordance with the data structure shown in FIG. 3. The warp correction value registration unit 18 extracts values of structure items of the circuit board from which a warp correction value has been calculated, and registers the warp correction value in the warp correction value database 14 in a corresponding relation to the extracted values of the structure items of the circuit board.

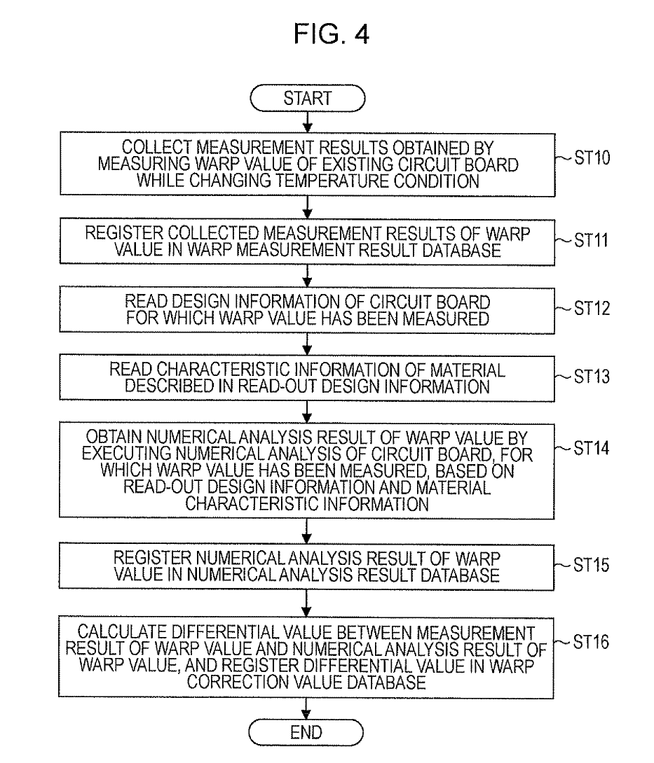

FIGS. 4 through 6 are flowcharts illustrating the circuit board deformation prediction apparatus 1.

The following exemplary description is given of process(es) executed by the circuit board deformation prediction apparatus 1.

The existing circuit board is heated while changing a temperature condition. The warp value of the circuit board undergoing the heating at each temperature condition is measured by the moiré interference method, the laser displacement measurement method, etc.

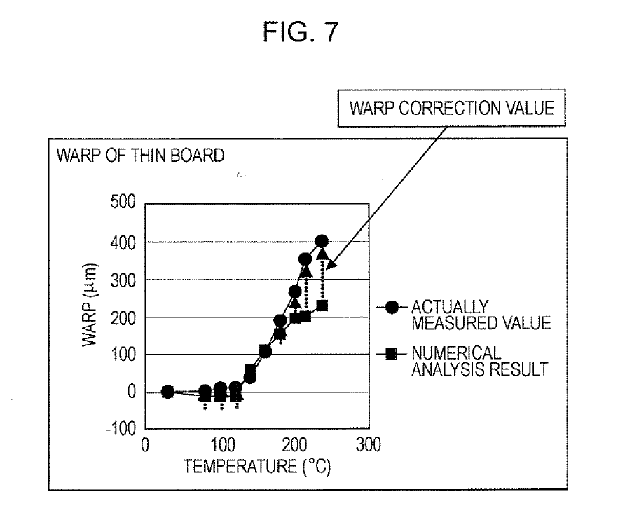

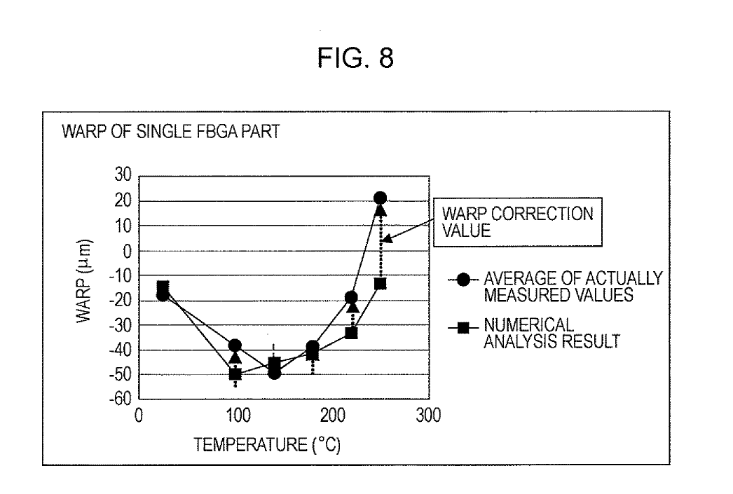

FIG. 7 illustrates an example of measurement results for a thin circuit board. FIG. 8 illustrates an example of measurement results for an FBGA part. In each of FIGS. 7 and 8, a black circle mark represents the actually measured value as the measurement result. The measurement can be performed by measuring a maximum warp value. Further, the measurement can be performed to include warp values measured at several positions on a two-dimensional plane.

In operation ST10 of the flowchart of FIG. 4, the circuit board deformation prediction apparatus 1 collects the warp values of the existing circuit board, which have been measured while changing the temperature condition.

In operation ST11, the circuit board deformation prediction apparatus 1 registers the measurement results, i.e., the collected warp values, in the warp measurement result database 12.

In operation ST12, the circuit board deformation prediction apparatus 1 reads, from the design information database 10, the design information of the circuit board for which the warp values have been measured.

In operation ST13, the circuit board deformation prediction apparatus 1 reads the characteristic information of the material, which is described in the design information, from the material characteristic information database 11.

In operation ST14, the circuit board deformation prediction apparatus 1 obtains a numerical analysis result for each warp value of the circuit board for which the warp values have been measured, based on the read-out of design information and material characteristic information. In other words, the circuit board deformation prediction apparatus 1 performs a numerical analysis of the warp value of the circuit board while changing the temperature condition.

FIG. 7 also illustrates an example of numerical analysis results for the thin circuit board. FIG. 8 also illustrates an example of numerical analysis results for the FBGA part. In each of FIGS. 7 and 8, a black square mark represents the numerical analysis result. The numerical analysis can be performed by measuring a maximum warp value. Further, the numerical analysis can be performed to include warp values measured at several positions on a two-dimensional plane.

In operation ST15, the circuit board deformation prediction apparatus 1 registers the numerical analysis result of the warp value, which has been obtained by the numerical analysis, in the numerical analysis result database 13.

In operation ST16, the circuit board deformation prediction apparatus 1 calculates a differential value between the measurement result of the warp value, which is stored in the warp measurement result database 12, and the numerical analysis result of the warp value, which is stored in the numerical analysis result database 13. The circuit board deformation prediction apparatus 1 registers the calculated differential value as the warp correction value in the warp correction value database 14.

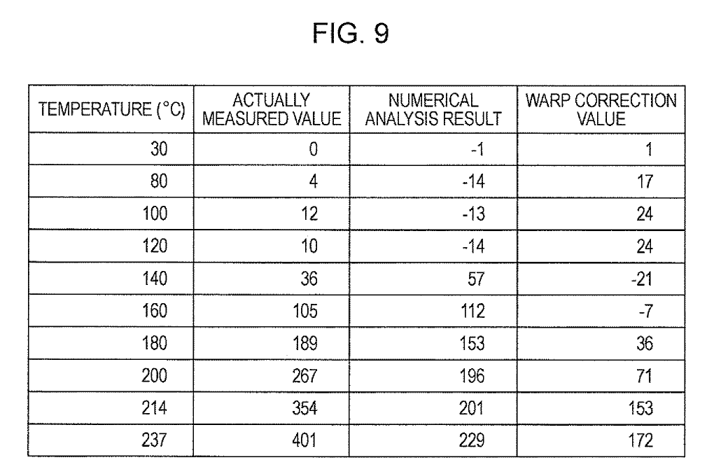

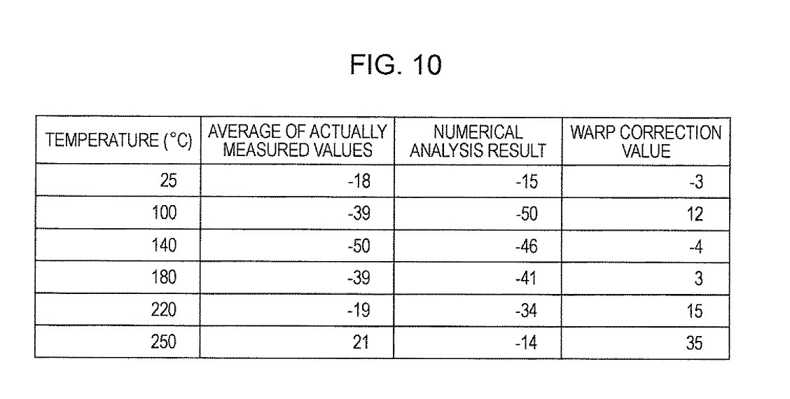

Based on the measurement result and the numerical analysis result shown in FIG. 7, the circuit board deformation prediction apparatus 1 calculates each warp correction value shown, by way of example, in FIG. 9. Then, the circuit board deformation prediction apparatus 1 registers the calculated warp correction value in the warp correction value database 14. Also, based on the measurement result and the numerical analysis result shown in FIG. 8, the circuit board deformation prediction apparatus 1 calculates each warp correction value shown, by way of example, in FIG. 10. Then, the circuit board deformation prediction apparatus 1 registers the calculated warp correction value in the warp correction value database 14.

In the above disclosed process, when the warp correction value database 14 has the data structure shown in FIG. 2, the circuit board deformation prediction apparatus 1 registers, in the warp correction value database 14, the warp correction value in a corresponding relation to the model name (or the type number) of the circuit board.

Further, when the warp correction value database 14 has the data structure shown in FIG. 3, the circuit board deformation prediction apparatus 1 registers, in the warp correction value database 14, the warp correction value in a corresponding relation to the values of the structure items of the circuit board.

Thus, the circuit board deformation prediction apparatus 1 constructs the warp correction value database 14 containing the warp correction values which have been obtained from the measurement results and the analysis results of the existing circuit board.

Alternatively, the circuit board deformation prediction apparatus 1 can construct the warp correction value database 14 by using warp value measurement results of a circuit board having been produced, after performing a numerical analysis of a warp value of that circuit board prior to the production.

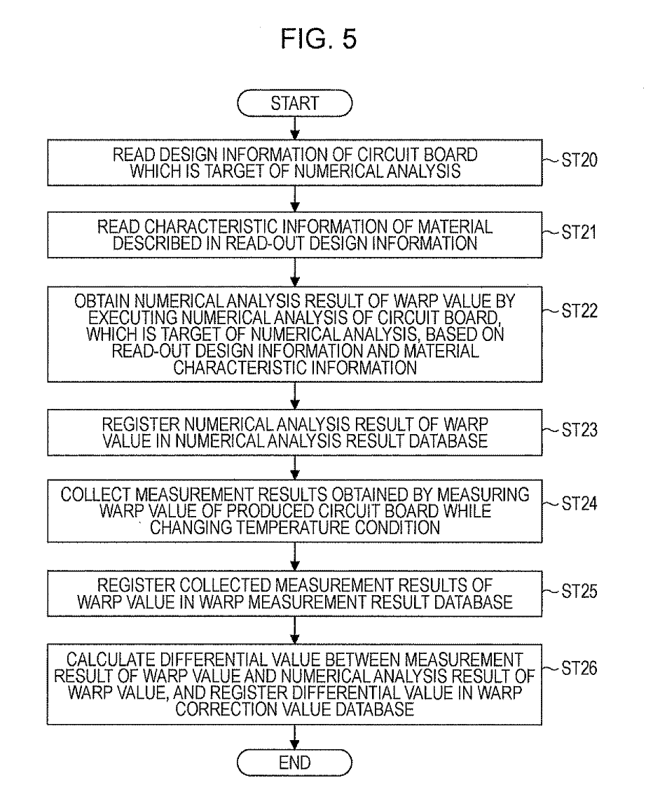

FIG. 5 is a flowchart illustrating process(es) executed in the above case as described below. In operation ST20, the circuit board deformation prediction apparatus 1 reads, from the design information database 10, the design information of a circuit board which is a target of the numerical analysis. In operation ST21, the circuit board deformation prediction apparatus 1 reads, from the material characteristic information database 11, the characteristic information of the material which is described in the read-out design information,

In operation ST22, based on the read-out design information and material characteristic information, the circuit board deformation prediction apparatus 1 obtains a numerical analysis result of the warp value of the circuit board by utilizing the numerical analysis method described in, e.g., the above-cited Non-Patent Document. In operation ST23, the circuit board deformation prediction apparatus 1 registers the numerical analysis result of the warp value of the circuit board in the numerical analysis result database 13.

Next, the circuit board having been subjected to the numerical analysis is heated while changing the temperature condition. The warp value of the circuit board under the heating at each temperature condition is measured by, e.g., the moiré interference method, the laser displacement measurement method, etc. In operation ST24, the circuit board deformation prediction apparatus 1 collects the warp value measurement results. In operation ST25, the circuit board deformation prediction apparatus 1 registers the measurement results in the warp measurement result database 12.

In operation ST26, the circuit board deformation prediction apparatus 1 calculates, as the warp correction value, a differential value between the measurement result of the warp value, which is stored in the warp measurement result database 12, and the numerical analysis result of the warp value, which is stored in the numerical analysis result database 13. Further, the circuit board deformation prediction apparatus 1 registers the calculated warp correction value in the warp correction value database 14.

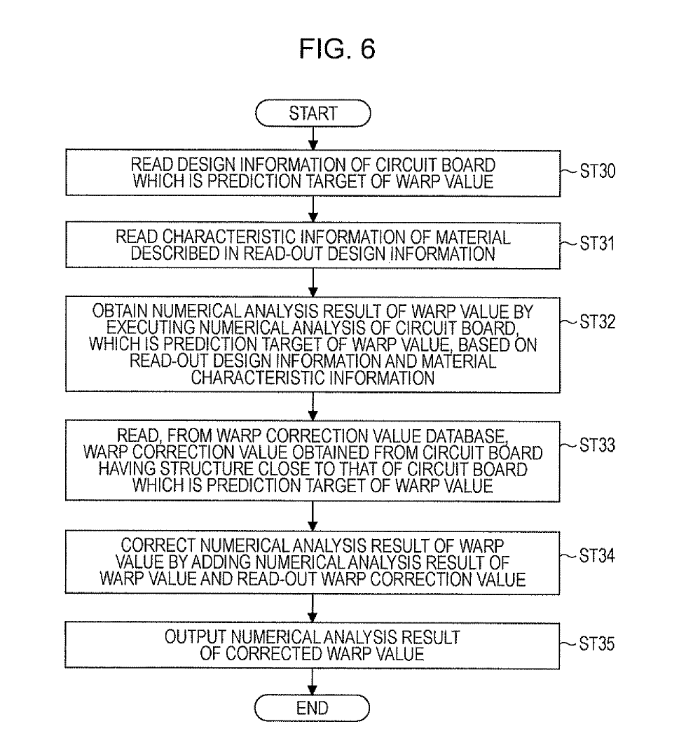

In response to a request for predicting a warp value of a newly designed circuit board, the circuit board deformation prediction apparatus 1 predicts the warp value of that circuit board. FIG. 6 illustrates a prediction process in that case.

In operation ST30, the circuit board deformation prediction apparatus 1 reads the design information of the circuit board from the design information database 10 in response to the prediction request.

In operation ST31, the circuit board deformation prediction apparatus 1 reads, from the material characteristic information database 11, the characteristic information of the material which is described in the read-out design information.

In operation ST32, the circuit board deformation prediction apparatus 1 performs a numerical analysis of the warp value of the circuit board. The warp value is calculated by utilizing the numerical analysis method, which is described in, e.g., the above-referred to Non-Patent Document, based on the read-out design information and material characteristic information. Further, the circuit board deformation prediction apparatus 1 performs the numerical analysis of the warp value at each of various temperature conditions,

In operation ST33, the circuit board deformation prediction apparatus 1 extracts a circuit board having a structure close to that of the target circuit board. The circuit board deformation prediction apparatus 1 reads the warp correction value of the extracted circuit board from the warp correction value database 14.

In operation ST34, the circuit board deformation prediction apparatus 1 adds the numerical analysis result of the warp value, which has been obtained in operation ST32, and the warp correction value which has been read out in operation ST33. Thus, the circuit board deformation prediction apparatus 1 corrects the warp value, which has been obtained as the numerical analysis result in operation ST32, to a value resulting from the addition.

In operation ST3S5, the circuit board deformation prediction apparatus 1 outputs the corrected warp value as the numerical analysis result.

As described above, the circuit board deformation prediction apparatus 1 performs the numerical analysis of the warp value of the circuit board. Further, the circuit board deformation prediction apparatus 1 corrects the warp value based on the differential information between the warp value of the circuit board, which has been obtained by the numerical analysis in the past, and the warp value of the circuit board, which has been actually measured in the past.

Generally, the structure of a circuit board for which a warp value is to be predicted is similar to the structure of a circuit board from which the former circuit board has been improved. Also, the structure of the circuit board affects the warp value of the circuit board to a large extent.

Accordingly, the circuit board deformation prediction apparatus 1 can correct the warp value of an improved circuit board, which is predicted at that time, by using the warp correction value obtained from the circuit board which is an original version of the improved circuit board. As a result, the circuit board deformation prediction apparatus 1 can increase the accuracy in predicting the warp value of the circuit board.

Meanwhile, according to the typical technique, the numerical analysis of the warp value of the circuit board is performed by using material characteristic information that is obtained by actually measuring the circuit board.

Material characteristic information of a circuit board including a resin contains an error at a temperature not lower than the glass transition point. Therefore, the warp value resulting from the numerical analysis based on such material characteristic information also contains a large error. For example, crosswise-braided glass fibers impregnated with a resin are generally used as material of a circuit board. The material of the circuit board is tested for stress relaxation by using the three-point bending method. In the test, the circuit board is irregularly warped due to a large drop in rigidity of the material of the circuit board at temperature not lower than the glass transition point. Hence the material characteristic information of the circuit board contains an error.

As a result, the prediction of the warp value of the circuit board by the numerical analysis based on such material characteristic information cannot have accuracy at a level demanded.

In contrast, according to the disclosed system and method, a warp deformation of the existing circuit board is actually measured in advance. Also, a warp deformation may be calculated by a numerical analysis. A differential value in the warp deformation between an actually measured result and a numerical analysis result is calculated. The differential value is stored as a warp correction value for the relevant circuit board. Further, warp correction values may be calculated for a plurality of circuit boards and the calculated warp correction values are stored in a database. When predicting a warp deformation of a new circuit board, according to the embodiment, the warp deformation of the new circuit board is calculated by the numerical analysis of that circuit board. The warp correction value of a circuit board, which is similar to the new circuit board, is obtained from the database. Further, according to the embodiment, the warp correction value is added to the numerical analysis result, thus calculating a prediction value of the warp deformation of the circuit board. As a result, a user can obtain the prediction value of the warp deformation, which is closer to an actual value.

As described above, the numerical analysis result correction unit 19 reads, from the warp correction value database 14, the warp correction value derived from data of a circuit board having a structure close to that of the circuit board for which the warp value is to be predicted.

FIG. 2 illustrates an example of the data structure of the warp correction value database 14. By utilizing the warp correction value database 14 shown in FIG. 2, the numerical analysis result correction unit 19 selects the warp correction value based on, for example, the model name of a circuit board, i.e., an original version of the circuit board for which the warp value is to be predicted.

FIG. 3 illustrates an example of the data structure of the warp correction value database 14. The numerical analysis result correction unit 19 compares values of structure items of the circuit board to be predicted for the warp value with corresponding values of structure items for each of other circuit boards, which are registered in the warp correction value database 14 shown in FIG. 3. The numerical analysis result correction unit 19 selects, from the warp correction value database 14, the warp correction value of the circuit board which provides a maximum number of matches with the values of the structure items of the circuit board to be predicted for the warp value. When the item value is a numerical value, the numerical analysis result correction unit 19 determines a match between two compared item values if the difference between those two compared item values is within a preset threshold range. For an item value regarding the structure such as the mounting type and the kind of material, the numerical analysis result correction unit 19 performs the comparison without requiring setting of a threshold.

In the above process, the numerical analysis result correction unit 19 may evaluate the number of matches by setting a weight for each of the structure items registered in the warp correction value database 14 and by calculating a total weight. For example, the numerical analysis result correction unit 19 adds 3 as the number of matches if a match is determined for the number of layers of the circuit board, and adds 1 as the number of matches if a match is determined for the size of the circuit board.

Further, the numerical analysis result correction unit 19 is not always required to evaluate a match/mismatch for the size of the circuit board. The reason is that, when a match is determined for the structure except for the size, the numerical analysis result correction unit 19 can obtain the warp correction value with substantially satisfactory accuracy through a correction operation of multiplying a certain ratio.

The process of selecting the warp correction value will be described below in connection with several practical examples.

When a target for prediction of a warp deformation is an LSI package, for example, the numerical analysis result correction unit 19 executes processing as follows. The numerical analysis result correction unit 19 makes a determination based on chip dimensions (thickness, width, length, etc) and package dimensions (thickness, width, length, etc) of a product which is the prediction target. More specifically, the numerical analysis result correction unit 19 sets upper and lower allowable error limits for each dimension in terms of percentage and selects the warp correction value that is managed in a corresponding relation to a product among a plurality of products registered in the warp correction value database 14, which has dimensions within the respective allowable ranges.

When a target for prediction of a warp deformation is a resin-molded LSI package, for example, the numerical analysis result correction unit 19 executes processing as follows. From among products registered in the warp correction value database 14, the numerical analysis result correction unit 19 selects a plurality of products each having a structure close to that of the target product. The selection is performed based on characteristic data (i.e., a rate of thermal expansion, a glass transition point temperature, and a bending elastic modulus) regarding a resin material of the package. More specifically, the numerical analysis result correction unit 19 sets upper and lower allowable error limits for each item of the characteristic data in terms of percentage and selects the warp correction value that is managed in a corresponding relation to a product among the plurality of selected products, which has data values within the respective allowable ranges.

When a target for prediction of a warp deformation is a POP LSI part including a chip mounted to a substrate, for example, the numerical analysis result correction unit 19 executes processing as follows. From among the products registered in the warp correction value database 14, the numerical analysis result correction unit 19 selects a plurality of products each having a structure close to that of the target product. The selection is performed based on condition data (i.e., maximum pressure, temperature, and time) regarding a process of mounting the chip to the substrate. More specifically, the numerical analysis result correction unit 19 sets upper and lower allowable error limits for each item of the condition data in terms of percentage and selects the warp correction value that is managed in a corresponding relation to a product among the plurality of selected products, which has data values within the respective allowable ranges.

When a target for prediction of a warp deformation is a circuit board, for example the numerical analysis result correction unit 19 executes processing as follows. The numerical analysis result correction unit 19 makes a determination based on the size (width and length), the number of layers, the thickness of a solder resist, the thickness of each insulating layer and each conductor layer, and the wiring density of each conductor layer of a product which is the prediction target. More specifically, the numerical analysis result correction unit 19 makes the determination by setting upper and lower allowable error limits for each item in terms of a numerical value or percentage and selects the warp correction value that is managed in a corresponding relation to a product which has data values within the respective allowable ranges.

When a target for prediction of a warp deformation is a circuit board, for example, the numerical analysis result correction unit 19 executes processing as follows. The numerical analysis result correction unit 19 makes a determination based on a wiring material proportion on each of both sides as viewed from the center of the circuit board in the direction of thickness. Specifically, the numerical analysis result correction unit 19 selects the warp correction value that is managed in a corresponding relation to a product having a ratio between the wiring material proportions on both the sides, which is closest to that of the target product.

When a target for prediction of a warp deformation is a circuit board, for example, the numerical analysis result correction unit 19 executes processing as follows. The numerical analysis result correction unit 19 makes a determination based on a wiring material proportion of one or plural layers among wiring layers, which are positioned nearest to the front or rear surface of the circuit board, on both sides as viewed from the center of the circuit board in the direction of thickness. Specifically, the numerical analysis result correction unit 19 selects the warp correction value that is managed in a corresponding relation to a product having a ratio between the wiring material proportions on both the sides, which is closest to that of the target product.

When a target for prediction of a warp deformation is a circuit board, for example, the numerical analysis result correction unit 19 executes processing as follows. The numerical analysis result correction unit 19 makes a determination based on the material name of a main insulating layer or the model name. Specifically, the numerical analysis result correction unit 19 selects the warp correction value that is managed in a corresponding relation to a product made of a material which is closest to that of the target circuit board.

When a target for prediction of a warp deformation is a circuit board, for example, the numerical analysis result correction unit 19 executes processing as follows. The numerical analysis result correction unit 19 selects the warp correction value that is managed in a corresponding relation to a product which is matched in a parameter having a relatively large weight with the target product.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An attributive data prediction apparatus, comprising:
a storage unit storing differential information between a simulated value of attributive data of a product and an actually measured value of the attributive data of the product;
a prediction unit predicting attributive data of a new product by simulation of the new product using design information of the new product; and
a correction unit correcting the simulated attributive data of the new product based on the differential information stored.

2. The attributive data prediction apparatus according to claim 1, wherein each attributive data represents changes depending on ambient temperature.

3. The attributive data prediction apparatus according to claim 1, wherein the storage unit stores the differential information in a corresponding relationship with model information of the product, and
the attributive data prediction apparatus comprises a selection unit selecting the differential information that is to be used by the correction unit, where the differential information is stored in a corresponding relationship with the model information representing a model of the new product.

4. The attributive data prediction apparatus according to claim 1, wherein the storage unit stores the differential information in a corresponding relationship with a value of each design item in the design information, and
the attributive data prediction apparatus comprises a selection unit selecting the differential information to be used in the correction unit among the stored differential information based on the value of each design item of the new product.

5. The attributive data prediction apparatus according to claim 4, wherein the selection unit selects the differential information to correspond to the value of the design item that is close to a value of a corresponding design item of the new product.

6. The attributive data prediction apparatus according to claim 5, wherein the selection unit selects the differential information by considering a weight assigned to each design item.

7. The attributive data prediction apparatus according to claim 31 wherein the correction unit corrects the differential information based on a value of a design item of the new product and a value of a design item of the product for which the differential information has been selected by the selection unit.

8. The attributive data prediction apparatus according to claim 7, wherein the correction unit corrects the differential information based on a numerical ratio between the value of the design item of the new product and the value of the design item of the product for which the differential information has been selected by the selection unit.

9. An attributive data prediction method, comprising:
predicting attributive data of a new product by simulation using design information of the new product; and
correcting the predicted attributive data of the new product based on differential information between a simulated value of attributive data of at least one other product and an actually measured value of the attributive data of said at least one other product, where the differential information is stored.

10. A computer readable storage medium storing a program to cause a computer to operate as an attributive data prediction apparatus and execute operations, the operations comprising:
predicting attributive data of a new product by simulation using design information of the new product; and
correcting the predicted attributive data of the new product based on differential information between a simulated value of attributive data of at least one other product and an actually measured value of the attributive data of said at least one other product, where the differential information is stored.

11. A method of predicting attributive data, comprising:
storing warp correction values resulting from previous calculations;
obtaining a warp value among said warp correction values having structure items matching a circuit; and
determining a correction value and predicting attribute data of said circuit by calculating a differential value between said warp value and a numerical analysis of said warp value.
